(19) United States
(12) Patent Application Publication
(10) Pub. No.: US 2026/0184028 A1
(43) Pub. Date: Jul. 2, 2026

(54) METHOD FOR MANUFACTURING A DECORATED THERMOPLASTIC SHELL IN A SINGLE OPERATION

(71) Applicant: AIRBUS ATLANTIC, ROCHEFORT (FR)

(72) Inventor: Frédéric RODRIGUEZ, ROCHEFORT (FR)

(21) Appl. No.: 19/219,488

(22) Filed: May 27, 2025

(30) Foreign Application Priority Data
May 28, 2024 (FR) 2405462

(51) Int. Cl. B29C 70/44; B29C 35/02; B29K 101/12; B29K 105/04; B29L 31/00; B29L 31/30

(52) U.S. Cl. CPC B29C 70/44; B29C 35/02; B29K 2101/12; B29K 2105/04; B29L 2031/3076; B29L 2031/771

(57) ABSTRACT

A method for manufacturing an aircraft seat shell, from a thermoplastic multilayer structure, the method being characterized in that it includes: a step of laying the multilayer structure over an autonomous self-regulated heating mold; a step of applying a heating membrane directly over the multilayer structure; a step of applying a vacuum into the mold by means of the heating membrane, the vacuum producing a compression of the multilayer structure; a step of baking at a predefined temperature, according to a cycle regulated by the mold; and a step of demolding and trimming the obtained shell; the method further includes integrating a decorative film onto the multilayer structure during molding. An aircraft seat lining shell obtained by such a method is also provided.

### CROSS REFERENCE TO RELATED APPLICATIONS

This application is based on and claims priority under 35 U.S.C. § 119 to French Patent Application No. 2405462, filed on May 28, 2024, in the French Intellectual Property Office, the disclosure of which is incorporated by reference herein in its entirety.

### BACKGROUND

### Field

The present disclosure belongs to the field of methods for manufacturing parts made of composite materials, in particular shells made of composite materials. More particularly, it relates to a method for manufacturing a decorated thermoplastic shell, in a single operation.

The disclosure finds a direct, but not exclusive, application in the manufacture of aircraft seat lining shells, in particular those of the superior classes (first-class and business-class).

Indeed, in such seats, the lining shell is designed, among other things, to partially enclose the seat and thus delimit a private space for the passenger.

### BRIEF DESCRIPTION OF RELATED DEVELOPMENTS

The manufacture of composite material shells, especially for demanding applications such as airplane seats, relies on well-established methods having some limitations. Composite shells are widely used due to their lightness, mechanical strength and ability to be molded into complex shapes.

Traditional composite shell manufacturing methods often involve the use of thermosetting materials. These materials, such as epoxy and polyester resins, are transformed by an irreversible polymerization process that gives the final material its mechanical and thermal properties.

A commonly used technique is hand lay-up, where successive layers of fiber reinforcements, such as glass or carbon fiber, are impregnated with thermosetting resin and deposited into a mold. Resin Transfer Molding (RTM) is another widely used method. It involves injecting resin into a closed mold containing the fiber reinforcements, enabling better impregnation and higher quality of the finished part.

To harden thermosetting materials, molded parts are generally placed in an oven or autoclave. Vacuum bagging is often combined with the autoclave to improve layer consolidation and remove air bubbles. The autoclave uses a combination of high pressure and temperature to ensure that the resin polymerizes homogeneously and that the obtained part has optimum mechanical properties.

Although widely adopted, these methods have several notable limitations. Firstly, the thermosetting materials used are not recyclable. At the end of their life, these shells cannot be reworked into new materials, which poses significant environmental problems.

Secondly, the manufacturing process is complex and involves several steps. The need for oven or autoclave baking for polymerization adds time and costs to production. In addition, finishing the shells is often carried out manually, by applying a decorative film after demolding. This not only extends production time, but also increases the risk of defects and non-compliance.

Scientific articles and industry reports highlight these limitations. For example, according to “Wong, K., Rudd, C., Pickering, S. et al. Composites recycling solutions for the aviation industry. Sci. China Technol. Sci. Sci. 60, 1291-1300 (2017). https://doi.org/10.1007/s11431-016-9028-7”, the inability to recycle thermosetting materials is a major challenge for the aerospace industry, which is particularly looking to reduce its ecological footprint.

On the other hand, “Chardon G, Chanal H, Duc E, Garnier T. Study of surface finish of fiber-reinforced composite molds. Proceedings of the Institution of Mechanical Engineers, Part B: Journal of Engineering Manufacture. 2017; 231 (4): 576-587. doi: 10.1177/0954405415617929” discusses the additional costs and lead times associated with manual finishing steps in the composite shell manufacturing process. Indeed, this article examines the process of producing composite parts using molds made of Hextool (registered trademark), a carbon-fiber reinforced thermosetting plastic. It highlights the need for manual finishing to meet surface quality and dimensional requirements. In particular, it emphasizes that the manual polishing operation is essential to achieve a specific surface roughness, and provides methods to optimize the milling process to minimize manual finishing time.

In contrast, thermoplastic materials offer a promising alternative. Unlike thermosets, thermoplastics can be melted and reshaped, making them easier to recycle. In addition, manufacturing methods using thermoplastics can potentially integrate finishing steps directly into the mold, thus simplifying the production line and reducing costs.

Existing solutions highlight the need for innovations in the field of composite shell manufacturing methods, aiming at overcoming current limitations and offering more efficient and ecological solutions.

### SUMMARY

The present disclosure aims at overcoming all or part of the drawbacks of prior art set out above, by providing an innovative solution in the form of a “one-shot” method allowing directly making decorated and recyclable thermoplastic shells. Indeed, the decorated shell is obtained in a single operation by virtue of an autonomous regulated heating mold, for integrating the finish at the same time.

An objective of the disclosure is therefore to reduce manufacturing steps, thereby reducing costs and time while improving the durability and ecological footprint of the finished products.

To this end, one object of the present disclosure is a method for manufacturing an aircraft seat shell, from a thermoplastic multilayer structure, said method being remarkable in that it comprises:
1. a step of laying the multilayer structure over an autonomous self-regulated heating mold;
2. a step of applying a heating membrane directly over the multilayer structure;
3. a step of applying vacuum into the mold by means of the heating membrane, said vacuum producing compression of the multilayer structure;
4. a step of baking at a predefined temperature, according to a cycle regulated by the mold; and
5. a step of demolding and trimming the obtained shell;

This method further comprises integrating a decorative film onto the multilayer structure during molding, prior to the baking step.

This one-step method, in the sense that it integrates all manufacturing steps including applying the decorative film into the molding process, allows reducing the production time by combining several steps in one operation. It also improves quality by ensuring uniform baking and integration of decoration, while simplifying the overall manufacturing process.

According to an advantageous aspect of the disclosure, the multilayer structure is prepared beforehand and comprises a honeycomb or foam core, sandwiched between two thermoplastic skins via adhesive films.

According to one aspect of the disclosure, the mold and the heating membrane respectively heat a lower part and an upper part of the multilayer structure.

Simultaneously heating both parts of the multilayer structure ensures homogeneous melting and superior molding quality, reducing the risk of deformation and blemishes.

According to one aspect, the baking step takes place according to a temperature profile having a constant step corresponding to the melting temperature of adhesive films contained in the multilayer structure.

The regulated temperature profile ensures that the adhesive films reach their melting temperature, ensuring perfect adhesion and efficient consolidation of the multilayer structure.

One object of the disclosure is also a decorated thermoplastic shell, obtained by the method as set forth.

The resulting shell is directly decorated, eliminating the need for decorative post-treatments, reducing production cost and time.

More particularly, this shell comprises a honeycomb core sandwiched between two thermoplastic skins.

The honeycomb core provides excellent mechanical strength while maintaining minimal weight, ideal for aircraft applications.

More particularly, the honeycomb core is tubular and isotropic in the directions of the midplane of the thermoplastic skins.

The isotropic tubular core ensures uniform distribution of stresses, thus improving the structural performance of the shell and increasing its service life.

According to one aspect, the thermoplastic skins are reinforced with fibers selected from PEI, PPS, PC or PEEK.

The fundamental concepts of the disclosure having been set out hereinabove in their most elementary form, other details and features will become more apparent upon reading the following description with reference to the appended drawings, giving, as a non-limiting example, an aspect of a method for manufacturing a decorated thermoplastic shell, in accordance with the principles of the disclosure.

### BRIEF DESCRIPTION OF THE DRAWINGS

The figures are given merely for illustrative purposes for better understanding of the disclosure without limiting the scope thereof. The different elements may be schematically represented and are not necessarily plotted to scale. Throughout the figures, identical or equivalent elements bear the same reference numeral.

Thus, it is illustrated in:

FIG. 1: a synoptic of the main steps of a method for manufacturing a thermoplastic shell according to an aspect of the disclosure;

FIG. 2: a schematic section of a multilayer structure for implementing the method and from which the shell will be derived;

FIG. 3: an example temperature profile applied during the baking step;

FIG. 4: a diagram of the main elements for implementing the method, comprising an autonomous heating mold and a heating membrane;

FIG. 5: an example of a finished shell obtained by the method according to the disclosure.

### DETAILED DESCRIPTION

It should be noted that some technical elements well known to those skilled in the art are reminded herein to avoid any insufficiency or ambiguity in the understanding of the present disclosure.

In the aspect described hereinafter, reference is made to a method for manufacturing thermoplastic shells, mainly intended for manufacturing decorated lining shells for aircraft seats. This non-limiting example is given for a better understanding of the disclosure and does not exclude the implementation of the method in other industrial sectors to manufacture other types of parts.

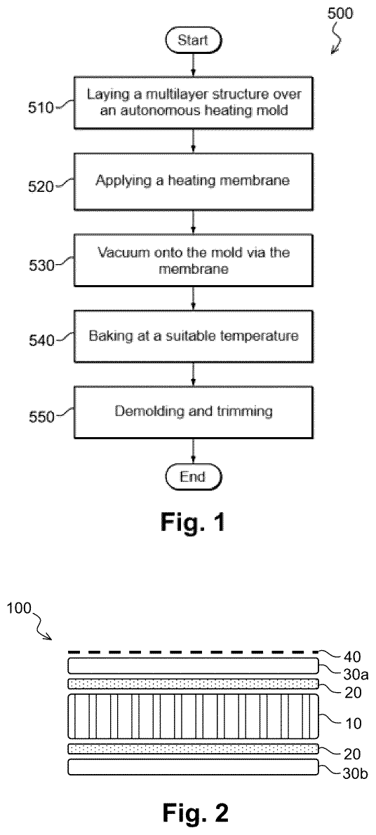

FIG. 1 shows the main steps of a method 500 for manufacturing a decorated thermoplastic shell, said method comprising:
1. an initial step 510 of laying a thermoplastic multilayer structure over an autonomous heating mold;
2. a step 520 of applying a heating membrane over the multilayer structure;
3. a step 530 of applying vacuum to the mold via the heating membrane;
4. a step 540 of baking at a predefined temperature; and
5. a final step 550 of demolding and trimming the obtained shell.

The method 500 advantageously makes it possible to make a decorated thermoplastic shell in a single integrated operation, thereby minimizing the manufacturing steps and intermediate handling. Unlike traditional methods that require several separate draping, baking, and finishing steps, this “one-shot” method allows reducing costs, production time, and risk of errors while improving the quality, lightweight, and recyclability of the end products.

The step 510 of laying a thermoplastic multilayer structure over an autonomous heating mold consists in arranging a structure composed of several layers of thermoplastic materials onto a mold specially designed to be autonomously heated. This mold is equipped with temperature regulation systems to ensure uniform distribution of heat, which is essential for the proper progress of the following steps.

FIG. 2 shows a multilayer structure 100 for implementing the method 500. The multilayer structure 100 comprises a honeycomb core 10, tubular with an isotropic behavior in the directions of the plane, sandwiched between two thermoplastic skins, an upper skin 30a and a lower skin 30b, via adhesive films 20. A decoration film 40 is applied over the upper skin 30a during the method.

The honeycomb core 10 is designed to provide good mechanical strength while minimizing the final weight of the shell that will be obtained. This isotropic structure ensures uniform distribution of stresses.

Alternatively, the core 10 may be foam.

The adhesive films 20 are placed on either side of the honeycomb core 10. These films allow the layers to be assembled, ensuring a strong long-lasting bond between the core 10 and the thermoplastic skins 30a and 30b. The adhesives used are selected for their compatibility with thermoplastic materials and their ability to withstand the manufacturing and end-use conditions. For example, they comprise a special adhesive.

The thermoplastic skins 30 are reinforced with fibers selected from materials such as PEI (Polyetherimide), PPS (Polyphenylene Sulfide), PC (Polycarbonate) or PEEK (Polyetheretherketone). These materials provide an ideal combination of strength, rigidity and lightness, while being able to undergo the heating and molding processes required to manufacture the shell.

The decoration film 40 is applied to the outer surface of the upper thermoplastic skin 30a. This decorative film is integrated directly into the molding process, enabling an esthetically pleasing long-lasting finish without the need for additional post-treatment steps. The decorative film 40 is designed to withstand the stresses of use.

The multilayer structure 100 thus described is laid over the mold before the step 520 of applying the heating membrane.

The step 520 of applying the heating membrane over the multilayer structure 100 consists in placing a membrane, of the cover sheet type, capable of generating heat directly above the multilayer structure. This heating membrane ensures uniform pressure on the structure and improves adhesion between the different layers, while beginning the necessary melting process to form a homogeneous shell.

The step 530 of applying vacuum to the mold via the heating membrane consists in applying a negative pressure (or vacuum) through the heating membrane, which makes it possible to compress the assembly and remove air bubbles to ensure better consolidation of the thermoplastic layers. This depression also helps to hold the structure in place and ensure a high-quality, flawless finish.

The baking step 540 at an adapted temperature consists in heating the entire multilayer structure to a predefined temperature, corresponding to the melting temperature of the adhesive films 20. This baking is regulated by the autonomous mold, thus ensuring a constant and homogeneous temperature over the entire surface of the shell, which is crucial for achieving the desired mechanical and esthetic properties.

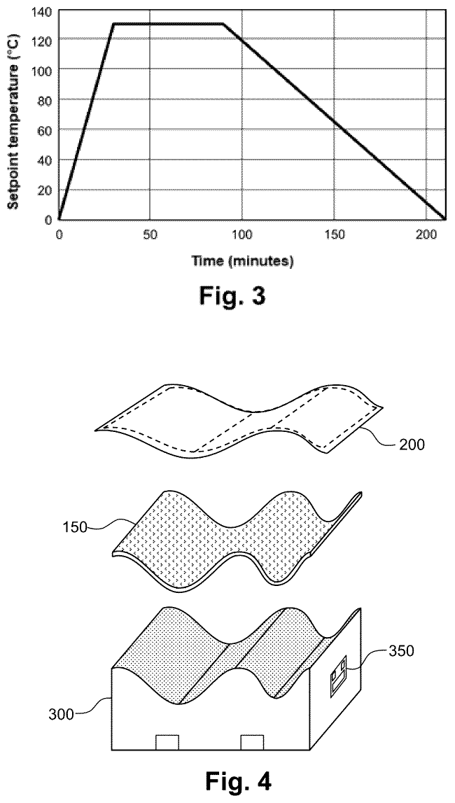

FIG. 3 shows an exemplary baking temperature profile used in step 540 of the method 500. This temperature profile makes it possible to ensure homogeneous melting and optimal hardening of the thermoplastic shell derived from the multilayer structure 100.

The graph shows that the setpoint temperature starts to increase rapidly right from the start of the process. From 0 to about 30 minutes, the temperature progressively rises until it reaches about 130° C. This heat-up phase allows preparing the multilayer structure for the melting phase.

Between 30 and 90 minutes, the temperature is kept constant at about 130° C. This thermal plateau phase ensures complete uniform melting of the thermoplastic materials, allowing good adhesion between the different layers and optimal consolidation of the structure.

After 90 minutes, the temperature starts to progressively decrease. This controlled cooling phase, which lasts from 90 to just over 200 minutes, allows the multilayer structure to solidify without introducing internal loads or deformations. The temperature returns to room temperature, guaranteeing that the thermoplastic shell is sufficiently hardened before demolding.

The final step 550 of demolding and trimming the obtained shell consists in gently removing the shell from the mold once the thermoplastic material has cooled and hardened enough. The shell is then trimmed to remove excess material and achieve the desired final dimensions. This step also includes final inspection to ensure the shell meets quality and design specifications.

FIG. 4 shows elements necessary for implementing the method 500 for manufacturing a decorated thermoplastic shell, these elements comprise in particular a mold 300 and a heating cover sheet 200.

The obtained shell 150 is demolded at the end of the method and is derived from the multilayer structure 100 initially laid into the mold.

The mold 300, of which only the self-heating lower part is shown, is equipped with a regulation system 350. The visible surface of the mold is heated, for uniformly heating the multilayer structure laid inside. The regulation system 350 provides precise control of thermal conditions, thereby ensuring homogeneous melting and hardening of thermoplastic materials.

In particular, the regulation system 350 continuously adjusts the temperature to maintain the ideal baking conditions, according to the temperature profile of FIG. 3 for example.

The heating cover sheet 200 is intended to be placed under the upper part of the mold, as indicated by the dotted lines in the figure. This cover sheet allows the upper part of the multilayer structure to be heated while exerting compression pressure through vacuum applied. This compression ensures perfect adhesion between the different layers and a homogeneous finish of the shell.

After the baking phase, which involves a thermal plateau followed by a controlled cooling phase, the shell 150 is formed. The shell, now solidified and decorated, is demolded. Demolding is done gently to preserve the integrity of the shell and guarantee a perfect finish.

The shell 150, made sandwiched with a visible decor on its upper face, is the result of the molding process. After having undergone the different heating, compression and cooling steps, the shell is demolded and has a robust and decorated structure. The decor integrated during molding eliminates the need for additional post-treatments, reducing costs and production time.

The method 500 thus enables efficient and integrated manufacture of decorated thermoplastic shells, in a single molding operation, reducing intermediate handling and improving the quality and durability of the final product. The combined use of the heating cover sheet 200 and the self-heating mold 300 with a regulator 350 ensures optimized production, both in terms of time and cost, while providing the desired performance of the shells manufactured.

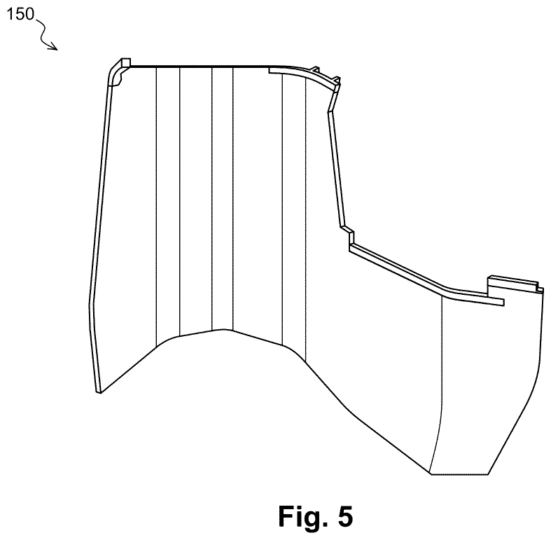

FIG. 5 shows an example of the final shell 150 obtained after implementing the described method.

The shell 150 has a smooth and decorated external surface that meets the esthetic and functional requirements for use in first-class and business-class airplane seats. The integrated decor, visible on the upper face, has been applied directly during the molding process, ensuring a homogeneous finish without the need for additional post-treatment steps.

As described, the method for manufacturing decorated thermoplastic shells set forth provides many advantages. The recyclability of the used thermoplastic materials allows for a more ecological management of products at the end of their life. Production in a single operation, using an autonomous self-regulated heating mold, significantly reduces manufacturing times and associated costs. In addition, the integration of the decor during the molding operation ensures a homogeneous esthetically pleasing finish without additional post-treatment steps.

Some non-essential steps can be added to the method depending on industrial needs, such as the application of additional protective coatings or the integration of specific structural reinforcements. Minor adjustments, such as changing temperature and pressure parameters depending on the materials used, can also be made to optimize the quality and performance of the shells produced. This flexible efficient method thus meets the high requirements of aircraft applications and other fields requiring lightweight robust components.

For example, the method may include an additional step of preheating the multilayer structure prior to applying the heating membrane. This preheating reduces thermal stresses when applying vacuum and ensures better melting of the thermoplastic layers.

In another alternative, the autonomous heating mold can be equipped with integrated pressure sensors, for regulating not only the temperature but also the pressure exerted on the multilayer structure. This precise pressure regulation can improve the quality of the melt and consolidation of the layers, thereby reducing potential defects.

Another technical alternative contemplates the use of thermoplastic skins having localized reinforcements in specific zones of the shell, such as zones for attachment or connection to other components of the seat. These localized reinforcements can be obtained by adding additional fibers in these zones, thereby increasing mechanical strength without significantly increasing the total weight of the shell.

Finally, in an additional variant, the method may include a thermal imaging inspection step after baking and before demolding. This inspection can detect possible internal defects or poorly melted zones, ensuring that only the optimum quality shell is demolded and ready for use.

What is claimed is:

1. A method for manufacturing an aircraft seat shell, from a thermoplastic multilayer structure, said method being characterized in that it comprises: a step of laying the multilayer structure over an autonomous self-regulated heating mold; a step of applying a heating membrane directly over the multilayer structure; a step of applying vacuum into the mold by means of the heating membrane, said vacuum producing a compression of the multilayer structure; a step of baking at a predefined temperature, according to a cycle regulated by the mold; and a step of demolding and trimming the obtained shell; said method further comprising integrating a decorative film onto the multilayer structure during molding, before the baking step.

2. The method according to claim 1, wherein the multilayer structure is prepared beforehand and comprises a honeycomb or foam core, sandwiched between two thermoplastic skins via adhesive films.

3. The method according to claim 1, wherein the mold and the heating membrane respectively heat a lower part and an upper part of the multilayer structure.

4. The method according to claim 1, wherein the baking step-takes place according to a temperature profile having a constant step corresponding to the melting temperature of adhesive films contained in the multilayer structure.

5. A decorated thermoplastic shell, obtained by a method according to claim 1.

6. The shell according to claim 5, comprising a honeycomb core sandwiched between two thermoplastic skins.

7. The shell according to claim 6, wherein the honeycomb core is tubular and isotropic in the directions of the midplane of the thermoplastic skins.

8. The shell according to claim 6, wherein the thermoplastic skins are reinforced with fibers selected from among PEI, PPS, PC or PEEK.
